(19) United States
(12) Patent Application Publication
(10) Pub. No.: US 2007/0127822 A1
(43) Pub. Date: Jun. 7, 2007

(54) Method and system for analyzing image differences

(76) Inventor: John H. Boose, Bellevue, WA (US)

Correspondence Address: KLEIN, O'NEILL & SINGH, LLP, 43 CORPORATE PARK, SUITE 204, IRVINE, CA, 92606, US

(21) Appl. No.: 11/339,599

(22) Filed: Jan. 25, 2006

Related U.S. Application Data
(60) Provisional application No. 60/742,120, filed on Dec. 2, 2005.

(51) Int. Cl. G06K 9/68

(52) U.S. Cl. 382/218

(57) ABSTRACT

Method and system for comparing two images using a computing system is provided. The method comprises comparing a first image with a second image, the first image and the second image described by one or more image attributes. The images further comprise a plurality of components described by one or more component attributes. The comparison of first image with second image is performed by comparing components of first image with components of the second image using a hierarchy of component attributes. A list of matched and unmatched components between the first image and second image is created. A report is generated out of the list based on report options.

### CROSS REFERENCE TO RELATED APPLICATIONS

This application claims priority under 35 U.S.C. 119(e) to the provisional patent application entitled “Intelligent Graphics Visual Difference Analyzer”, Ser. No. 60/742,120 filed on Dec. 2, 2005, the disclosure of which is incorporated herein by reference in its entirety.

### BACKGROUND OF THE INVENTION

1. Field of Invention

This invention relates generally to computing systems, and in particular, to a method of comparing digital images.

2. Background of the Invention

Conventional computer systems have been employed to analyze and process digital images. These digital images include, for example, photographic stills, digitally rendered graphics, video clips, monochrome or color digital images, hand drawn images scanned digitally, and the like. Image analysis and processing allows for comparison of a reference image against another image or multiple images in order to find a correlation between them. A variety of image matching techniques have been employed to determine such correlation between images.

One such image matching technique uses object classification to determine the correlation between the images. The reference image and a second image are each separated into objects based on geometric shapes and sizes and the objects of each image are measured and classified using measurement identifiers. A comparison of discrete objects of the reference image and objects of the second image using geometric shapes and sizes determine if the two images are matched or not.

Another image matching technique uses match filtering. Match filtering does a pixel-by-pixel comparison of a block of area in a reference image with a corresponding block of area in the second image. Based on the pixel-by-pixel match outcome, the block of area in the reference image is declared similar or different to the corresponding block of area in the second image.

Each of the aforementioned image matching techniques utilizes different types of data or partial image data to describe the physical characteristics (including orientation) of the images under comparison. In complex engineering drawings spanning multiple sheets where functional accuracy is of utmost importance, a component appearing in reference image and second image at different orientations or having different minor characteristics, such as one loop versus 2 or 4 loops, but serving the same function would be marked different using the aforementioned techniques. These types of image matching would create inaccurate matches resulting in confusion and wasted resources and time due to manual re-verification of the differences.

It is therefore desirable to provide an image matching technique that can generate a more accurate matching result by utilizing image data that is a substantial representation of the images under comparison.

### SUMMARY OF THE INVENTION

In one aspect of the present invention, a method for comparing two images using a computing system is provided. The method comprises comparing a first image with a second image, the first image and the second image distinctively described by one or more image attributes. The images further comprise one or more components distinctively described by one or more component attributes. The comparison of first image with second image is performed by comparing components of the first image with components of the second image using a hierarchy of component attributes. A list of matched and unmatched components between the first image and the second image is created. A report is generated out of the list based on report parameters. In one aspect of the invention the report is created using all matched components between the two images. In another embodiment of the invention, the report is created using all unmatched components between the two images. In one embodiment of the invention the report is generated dynamically and displayed on an output device of the computing system. In another embodiment of the invention, the report is generated as a file that can be printed or retrieved for later reference.

In yet another embodiment of the invention, a computing system used to compare images is provided. The computing system consists of a processor for executing an analyzer module. The analyzer module receives a first image and a second image from one or more image sources. The image sources are identified using one or more image attributes that distinctively describe the images. The images comprise one or more components, the components having one or more components attributes to distinctively describe the components. The analyzer 200 module compares the first image with the second image by comparing the respective components using a hierarchy of component attributes. A list of matched and unmatched components between the first image and second image is generated. The analyzer uses the list of matched and unmatched components to create one or more reports based on one or more report parameters.

This brief summary has been provided so that the nature of the invention may be understood quickly. A more complete understanding of the invention can be obtained by reference to the following detailed description of the preferred embodiments thereof in connection with the attached drawings.

### BRIEF DESCRIPTION OF THE DRAWINGS

The foregoing features and other features of the present invention will now be described with reference to the drawings of a preferred embodiment. The illustrated embodiment is intended to illustrate, but not to limit the invention. The drawings include the following:

FIG. 1 shows a block diagram of a computing system for executing process steps, according to one aspect of the present invention.

FIG. 2a shows the internal architecture of the computing system of FIG. 1. FIG. 2b shows the block diagram of the modules used in carrying out the steps involved in implementing the current invention.

FIG. 3 shows the process steps followed by the analyzer 200 in one aspect of the present invention.

FIG. 4a is a flowchart of the detailed steps involved in step S301 of FIG. 3. FIG. 4b provides a sample hierarchical list of component attributes.

FIG. 5 is a flowchart of the detailed steps involved in step S302 of FIG. 3.

FIGS. 6, 7, 8, 9, 10 and 11 show the reports created by the analyzer program in one embodiment of the present invention.

### DETAILED DESCRIPTION OF THE PREFERRED EMBODIMENTS

In one aspect of the present invention, a system and process are provided to compare a pair of images received from one or more sources and to generate a report identifying the components and linking the components with one or more component attributes. The report could be displayed on an output device attached to the system or could be created for later viewing.

To facilitate an understanding of the preferred embodiment, the general architecture and operation of a computing system will be described first. The specific process under the preferred embodiment will then be described with reference to the general architecture.

Computing System:

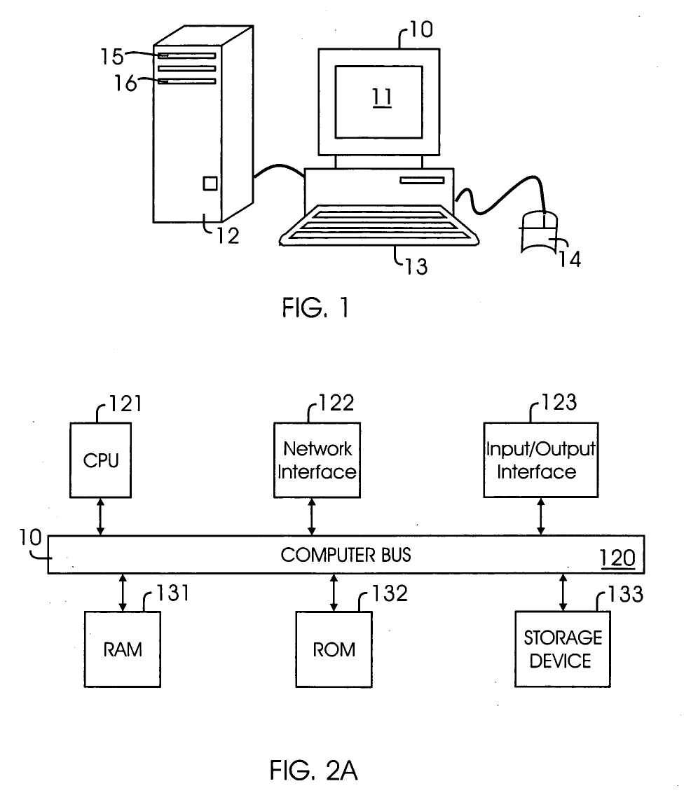

FIG. 1 is a block diagram of a computing system for executing computer executable process steps according to one aspect of the present invention. FIG. 1 includes a host computer 10 and a monitor 11. Monitor 11 may be a CRT type, a LCD type, or any other type of color or monochrome display.

Also provided with computer 10 are a keyboard 13 for entering data and user commands, and a pointing device (for example, a mouse) 14 for processing objects displayed on monitor 11.

Computer 10 includes a computer-readable memory storage device 15 for storing readable data. Besides other programs, storage device 15 can store application programs including web browsers and computer executable code, according to the present invention.

According to one aspect of the present invention, computer 10 can also use removable storage device 16 for storing data files, application program files, and computer executable process steps embodying the present invention (for example: floppy disk drive, memory stick, CD-ROM, or CD R/W (read/write) or other device).

A modem, an integrated services digital network (ISDN) connection, or the like also provide computer 10 with a Network connection 12 (for example: Internet)—to the network of computers within a company or entity in the company (for example: Intranet). The network connection 12 allows computer 10 to download data files from the Internet, application program files and computer-executable process steps embodying the present invention.

It is noteworthy that the present invention is not limited to the FIG. 1 architecture. For example, notebook or laptop computers, set-top boxes or any other system capable of connecting to the internet or intranet and running computer-executable process steps, as described below, may be used to implement the various aspects of the present invention.

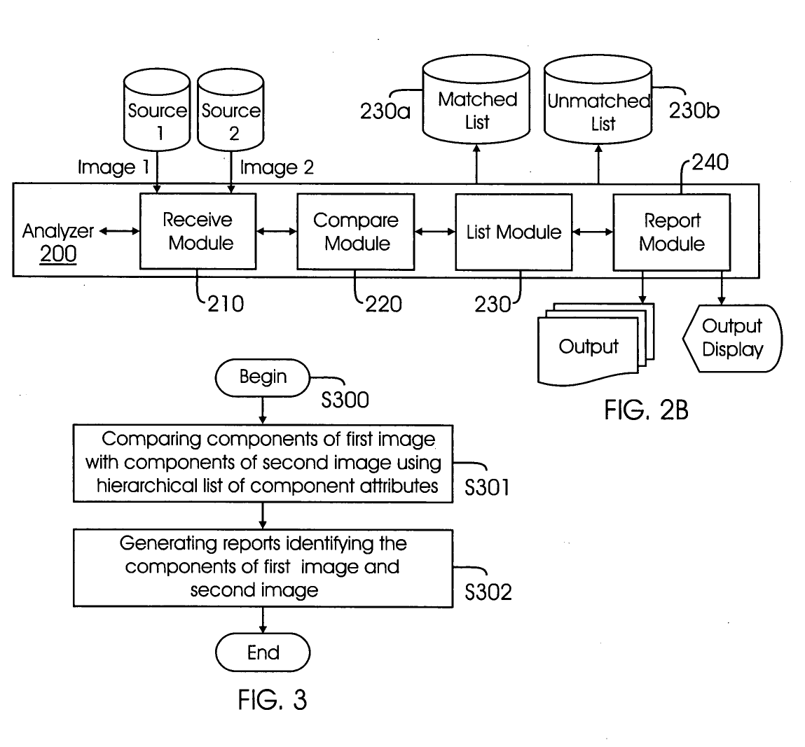

FIG. 2a shows a top-level block diagram showing the internal functional architecture of a computing system 10 that may be used to execute the computer-executable process steps, according to one aspect of the present invention. As detailed in FIG. 2, computing system 10 includes a central processing unit (CPU) 121 for executing computer-executable process steps and interfaces with a computer bus 120.

Computing system 10 includes an input/output interface 123 that operatively connects output display device such as monitors (11), input devices such as keyboards (13) and pointing device such as a mouse (14) to the computing system 10.

A storage device 133 (similar to storage device 15) also interfaces to the computing device 100 through the computer bus 120. Storage device 133 may be disks, tapes, drums, integrated circuits, or the like, operative to hold data by any means, including magnetically, electrically, optically, and the like. Storage device 133 stores operating system program files, application program files, computer-executable process steps, web-browsers and other files. Some of these files are stored on storage device 133 using an installation program. For example, CPU 121 executes computer-executable process steps of an installation program so that CPU 121 can properly execute the application program.

Random access memory (“RAM”) 131 also interfaces to computer bus 120 to provide CPU 121 with access to memory storage. When executing stored computer-executable process steps from storage device 133, CPU 121 stores and executes the process steps out of RAM 131.

Read only memory (“ROM”) 132 is provided to store invariant instruction sequences such as start-up instruction sequences or basic input/output operating system (BIOS) sequences.

The computing system 10 can be connected to other computing systems through the network interface 122 using computer bus 120 and network connection (not shown). The network interface 122 may be adapted to one or more of a wide variety of networks, including local area networks, storage area networks, wide area networks, the Internet, and the like.

In one aspect of the invention, an analyzer program 200 (analyzer 200, from FIG. 2b) to analyze two images may be supplied on a removable storage device 16 (for example: CD-ROM or a floppy disk), or alternatively could be read from the network via a network interface 122. In yet another aspect of the invention, the computing system 10 can load the analyzer 200 from other computer readable media such as magnetic tape, a ROM, integrated circuit, or a magneto-optical disk. Alternatively, the analyzer 200 is installed onto the storage device 133 of the computing system 10 using an installation program and is executed using the CPU 121.

In yet another aspect, the analyzer 200 may be implemented by using an Application Specific Integrated Circuit (ASIC) that interfaces with computing system 10.

The analyzer 200 as illustrated in FIG. 2b, can be considered to be made up of a plurality of modules each of which are used to carry out different steps of the current invention. A module in this application refers to a piece of software, hardware or ASIC that performs a particular function and can be combined with other modules.

The analyzer 200 comprises a receive module 210. The receive module 210 receives a plurality of image attributes. These image attributes are used to identify and extract a first image and a second image along with corresponding components from a single image source or multiple image sources. Turning in detail to FIG. 2b, image 1 and image 2 are identified and extracted from two different image sources—source 1 and source 2 respectively.

A compare module 220 is used to compare the first image with the second image identified by the receive module 210. The compare module 220 collaborates with the receive module 210 and uses the first image and second image identified by the receive module 210 using image attributes and component attributes received, to compare the two images and identify the differences between the two images.

A list module 230, interfacing with the compare module 220, generates a list of matched and unmatched component lists (230-a and 230-b) for the respective images based on the results of the compare step.

A report module 240 interfacing with the list module 230, uses the matched and unmatched list (230-a and 230-b) generated by the list module 230 to create reports of differences in the two images. The output shown in FIG. 2b illustrates the two options available—an online dynamic view option or a report file that can be stored on a storage device 15 and viewed later. Dynamic as used in this application refers to online real-time creation and viewing. For instance, a report created dynamically and viewed on a display device would indicate that the report is created online in real-time and the report is made available for viewing on a display device.

Analysis Step:

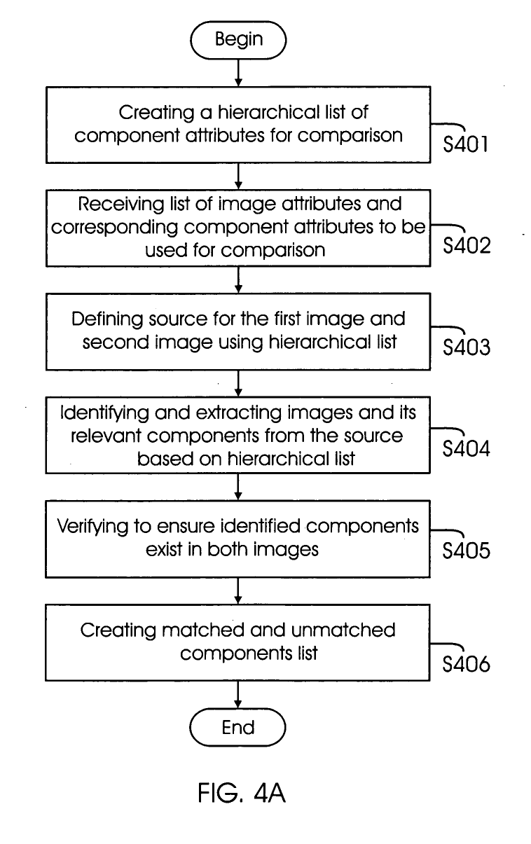

The method followed by the analyzer program 200 (analyzer 200) is now explained in greater detail with reference to FIG. 3.

Turning to FIG. 3 in more detail, in step S301, compare first mage with a second image using one or more components. According to one embodiment of the present invention, the first image and the second image are considered as graphic images. Other images can also be used in the implementation of the present invention.

The images are received into the computing system 10 from a plurality of sources. Some of the sources could include: a) graphic images dynamically generated from a database residing on the computing system 10 or residing on another computing device accessible by the first computing system 10 through network connection; b) graphic images created by graphical illustrators maintained in a storage device 133 on the computing system 10 or accessible by the first computing system 10 through network connection, c) hand-drawn graphic images that are uploaded to the computing system 10 using a scanning tool, or d) photographic stills, digitally rendered graphics, video clips, monochrome or color digital images uploaded to the computing system 10.

The first image and the second image are identified from any one or more sources using image attributes. Image attributes define in distinct detail the specific image that is needed for comparison. Some of the image attributes could be image identification, image description, image name, image revision description and image revision date. A plurality of attributes of the first image and the second image are received at the computing system 10 to enable identification and extraction of the correct image for comparison from the appropriate image source.

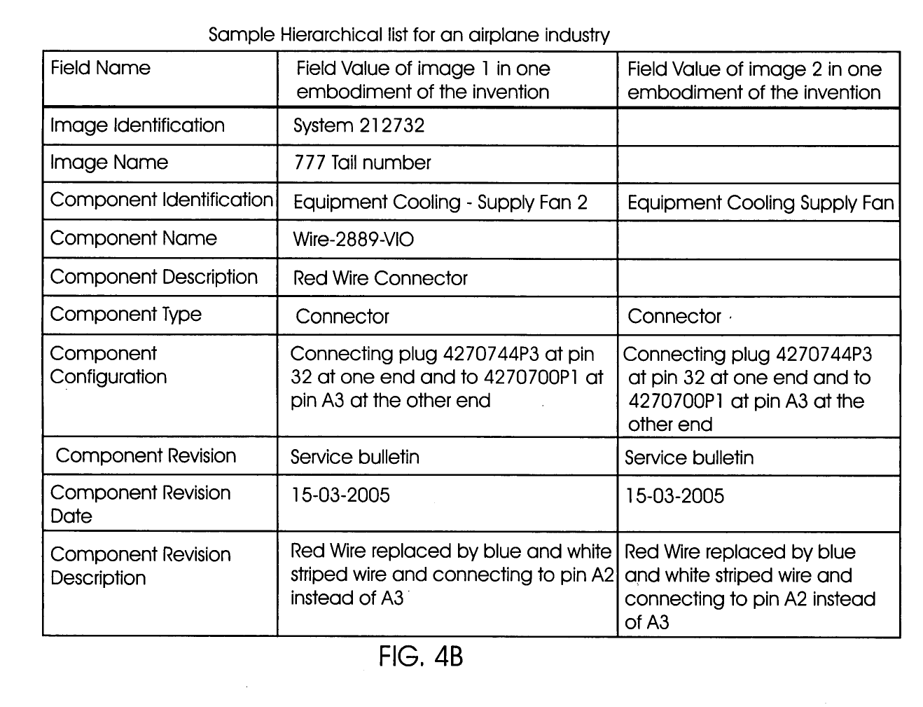

Each of the images further comprises a plurality of components. The components, in this embodiment of the invention, are various parts (sub-images) that make up the image. For example: Considering a wiring diagram of a system in a plane as an image, the component could be a wire within the wiring diagram. The components could also include one or more sub-components. Each of the components is distinctly described using one or more component attributes. The component attributes could include one or more of image identification, image description, image name, component identification, component name, component description, component type, component configuration, component revision identification, component revision date and component revision description. In the present invention, the component attributes are stored in a component database using storage device 133 and accessible by the analyzer 200 from computing system 10. Step S301 of FIG. 3 is explained in greater detail using the flowchart of FIG. 4a.

Turning in detail to FIG. 4a, in step S401, a list of image and component attributes are identified and used to create a hierarchical list of attributes for comparing the first image with the second image. A sample hierarchical list is provided in FIG. 4b for an image in an airline industry. The hierarchical list, in one embodiment, could include image identification, image name, image description, component identification, component name, component description, component type, component configuration, component revision identification, component revision date and component revision description. Hierarchical list provides the analyzer 200 with a standard sequence of attributes by which to identify the corresponding component in the images. For example: A component in one image could have a component name and a component identification to identify the component. The same component could exist in the second image and identified using the component revision identification and component revision description only. The analyzer 200 is capable of going through the list of component attributes for a component in one image with corresponding component in the second image and identify the components in both the images using the hierarchical list of attributes of the component. Establishing and following this hierarchical list can correctly identify the same component appearing in both the images.

In step S402, the analyzer 200 receives a list of image attributes to be used for identifying and comparing the images. The list of image attributes for identifying and comparing an image could include image identification, image name, image description, image revision identification, image revision description and image revision date. An input device 13 maybe used to enter the image attributes. For example: In an airline industry, the image could be that of a system in an airplane. The image attributes for identifying the first image and second image could be from two 777 tail numbers or it could be the wiring for airplane system 212732—“Equipment Cooling” Supply Fan 2.

In step S403, the source of the first image and the second image are identified using the image attributes received in step S402. The source for the first image could be different from the source of the second image and depends on the image attributes.

In step S404 the analyzer 200 identifies and extracts the images and its corresponding components using image attributes.

Step S405 is the comparison step where the components of the first image are compared against the components in the second image. In this step, the analyzer 200 verifies to see if the identified component in the first image exists in the second image. To accomplish this, the analyzer 200 identifies a component in the first image using the hierarchical list of component attributes. Once the component in first image is identified, the analyzer 200 then tries to identify a corresponding component in the second image using the same hierarchical list. When the second image's component is identified the two components are compared using any one or more of the component attributes of the respective components to see if they relate to the same component or different component.

In step S406, if the identified component in one image exists in the second image, the identified component is entered into that image's matched component list 230-a. If the identified component exists in the first image and not the second, the identified component is entered into the unmatched component list 230-b for the first image. If the identified component exists in the second image and not the first, the identified component of the second image is entered into the unmatched component list for the second image 230-b.

The matching process described in steps S405 and S406 could be explained with reference to the following example. A first image and a second image could be electrical drawings from two 777 tail numbers of an airplane in an airline industry. A component in the first and the second image could be a wire connecting two plugs. The match process begins by first identifying the wire in the first image. This could be accomplished by identifying the components in both the first image and the second image using component name, component identification, component description, component configuration, or any other component attributes from the hierarchical list. For example: The wire in the first image could be a red wire # Wire-2889-VIO connecting a plug 4270744P3 at pin 32 at one end and to plug 4270700P1 at pin A3 at the other end.

In this example, the component name would be a red wire, component identification could be Wire-2889-VIO, component description could be red wire connector, component configuration could be connecting plug 4270744P3 at pin 32 on one end to plug 4270700P1 at pin A3 at the other end and so on. The same wire in the second image could only have the following component attributes: component configuration of connecting plug 4270744P3 at pin 32 on one end to plug 4270700P1 at pin A3 at the other end.

The analyzer 200 goes over the component attributes of the component in the first image and the second image one by one using the hierarchical list of component attributes. If the component name is at the top of the hierarchical list, then the analyzer 200 program checks the component name first. If the component name does not match, the analyzer 200 then uses variation of component name using leading zeroes, trailing zeroes, leading spaces, trailing spaces, abbreviations or expansion of abbreviations. If there is no match in the component name, it proceeds to the next component attribute in the hierarchical list. For example: component identification. If no match yields in the second step of comparison, the analyzer 200 proceeds to the next attribute in the hierarchical list.

In the above case of the wire connecting the two plugs, the description of component in first image matches the description of component in the second image. Once an exact match results, the identified component in first image and second image are tagged matched, the matched component is added to a matched component list 230-a for the first image and the analyzer 200 proceeds to the next component. Alternatively, the matched component could be added to a matched component list 230-a for the second image or to the matched component list 230-a of both the first image and second image. The program proceeds in this way identifying and matching each of the components in the first image with the corresponding component in the second image.

If in the above example, the wire Wire-2889-VIO in first image is connected to plug 4270744P3 at Pin 32 on one end and to Pin A2 of plug 4270700P1 at the other end and the same wire in second image is connected to plug 4270744P3 at Pin 32 on one end and to Pin A5 of plug 4270700P1 at the other end, the identified component in first image is tagged unmatched, the unmatched component is added to a unmatched component list 230-b for the first image and the analyzer 200 program proceeds to the next component.

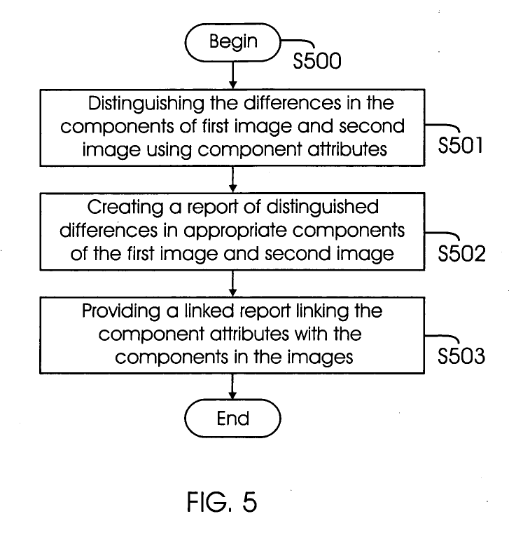

Referring back to FIG. 3 step S302, once the comparison of the components between the two images is completed, the analyzer 200 creates a report of the identified components from the list of matched and unmatched components 230-a and 230-b. The step of creating a report of the differences between the two images can be explained in greater detail by referring to the process steps of FIG. 5.

In step S501 of FIG. 5, the analyzer 200 uses the matched and unmatched list 230-a and 230-b to distinguish the difference between the appropriate components in the two images. Some of the ways of distinguishing the differences between components could be by using highlighting, bolding, underlining, or coloring in different color than the one it is displayed in, or putting a box around the components. The distinguished differences between the respective components of the two images are captured in a report. In one embodiment of the invention, the report is viewed online dynamically using an output device 11 attached to the computing system 10 or in a printable report form by storing the report on the storage device 15 of the computing system 10 for later retrieval. Other options to view the report are available based on the report options chosen.

A set of report options received by the analyzer 200 will enable the appropriate report to be created. Some of the report options could include dynamic viewing, creating a report, panning, zooming, single window viewing, multi-window viewing. The report could be text based or graphic based.

The analyzer 200 also provides a “hot” link between the list of unmatched component's component attributes and its corresponding position in the appropriate images when the report option of dynamic viewing is chosen. The “hot” link would enable one to select any component attribute in the list and the analyzer 200 would provide a closer view of that particular component in the image by zooming and panning to the appropriate component's position in the displayed image. The image could be zoomed and panned using a standard report viewer. This feature would enable one to get a closer view of the differences or similarities between the components.

In the case where the report option of dynamic viewing in a single window is chosen, the viewing window is split to display the images and its differences and similarities. The viewing window could be split either vertically or horizontally. In the current embodiment where two images are compared and a single window option is chosen, the viewing window is split horizontally into two. In another embodiment, where multi-window option is chosen, the viewing of the differences and similarities between the two images could be displayed on two different windows. In another embodiment, where more than two images are compared with a single window option, a single window could be split to accommodate viewing a plurality of images that are compared or in case of multi-window option a plurality of windows could be used to view the differences and similarities of the plurality of images.

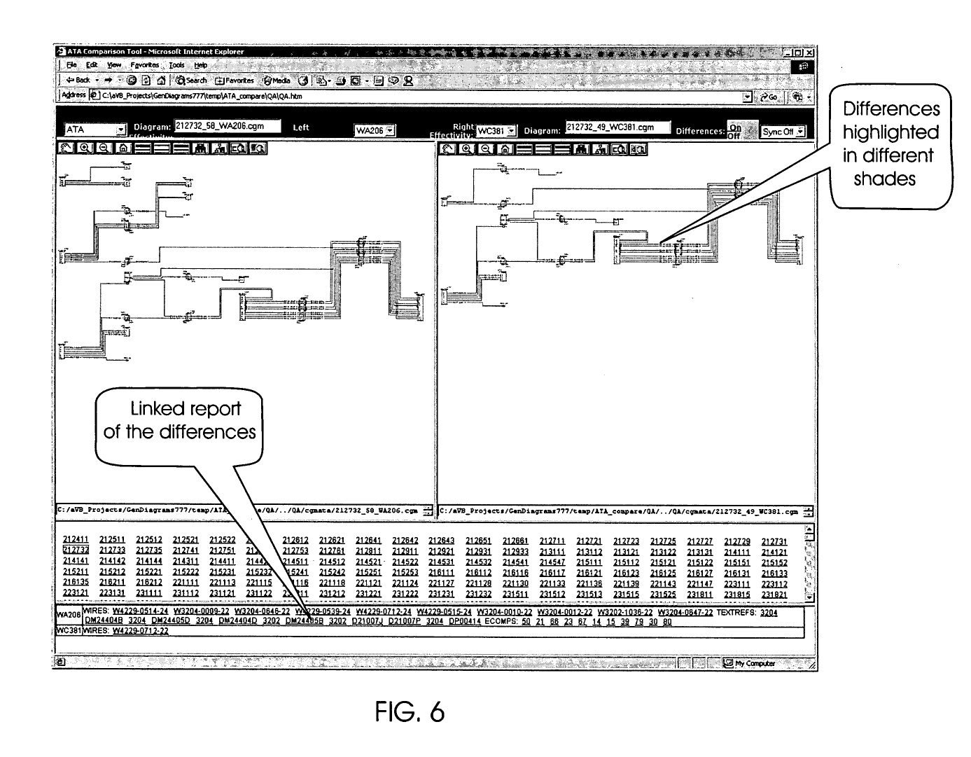

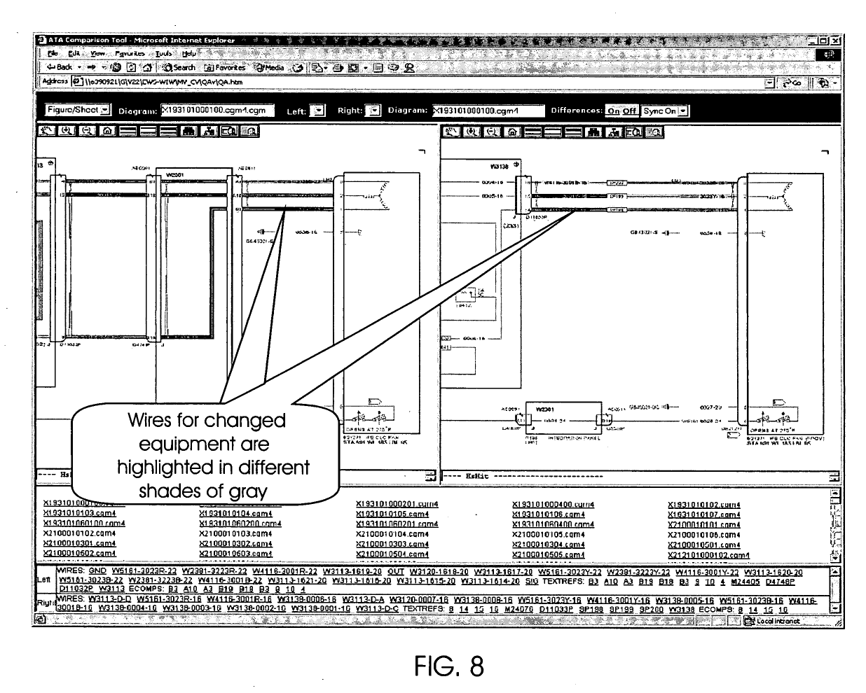

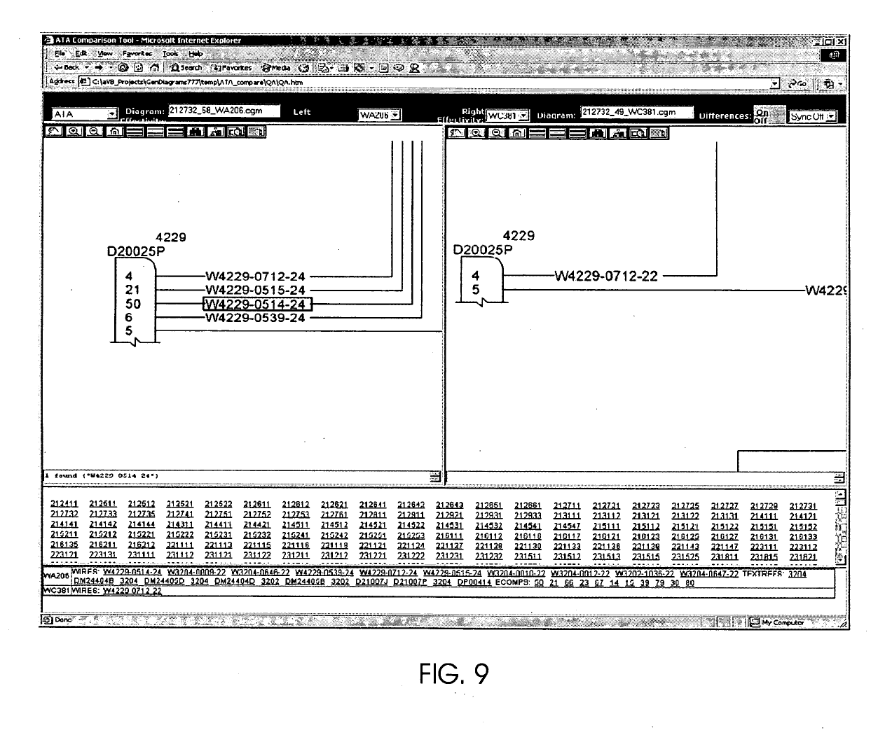

FIGS. 6 through 11 show how the analyzer 200 identifies the differences between one or more components in the first image and the second image, in one embodiment of the invention. FIG. 6 shows the difference between the components in two images identified by the analyzer 200. Lists of components that are different are provided at the bottom of the screen. FIG. 6 reflects the report options chosen—to dynamically display the differences in a single window split vertically to show the differences and similarities of the two images on an output device attached to the computing system 10 that is executing the analyzer 200.

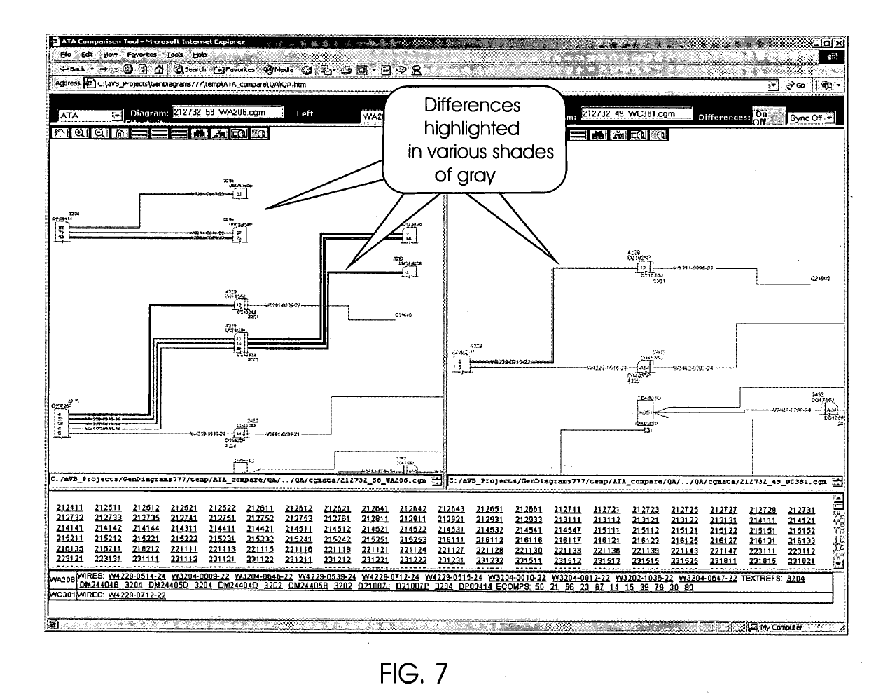

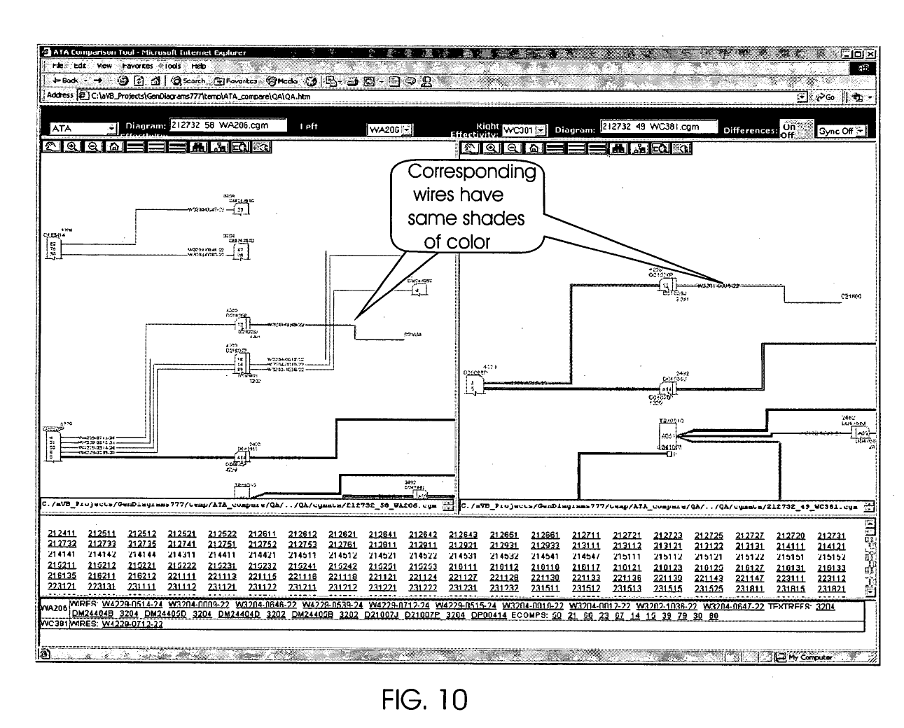

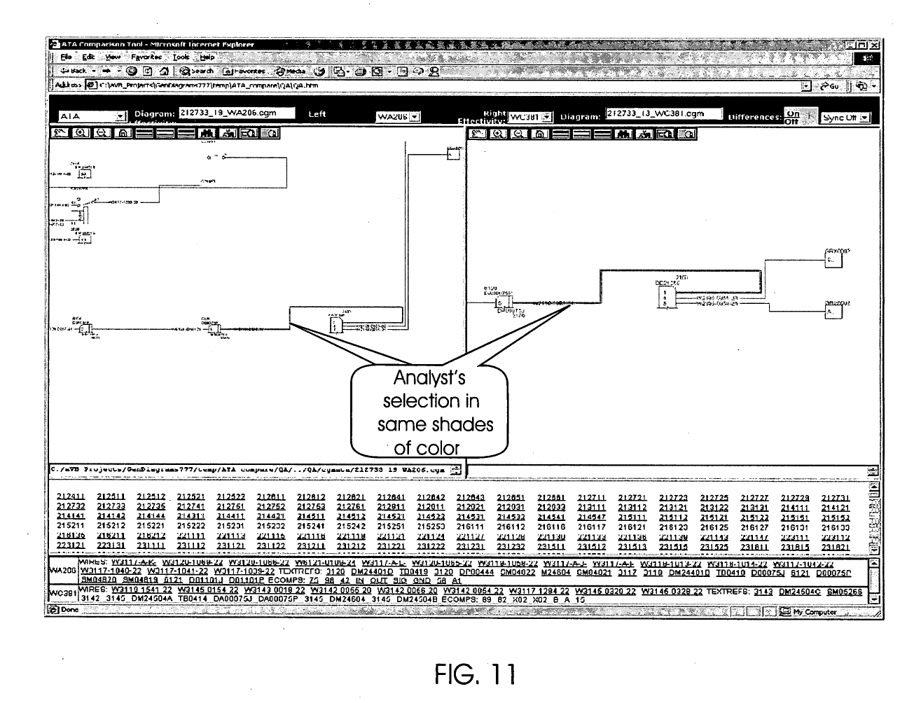

FIGS. 7, 8 and 9 show the difference in the components highlighted in varying shades of gray. The difference is displayed on an output device attached to the computing system 10 that is executing the analyzer 200. FIGS. 10 and 11 show the differences in two components displayed in a side-by-side display with similar components in the two images illustrated in the same color. FIG. 11 shows the selected component in the two images in the same color.

The current invention has been explained in great detail by using two images for comparison. The invention is not restricted to comparing just two images but can be extended to include more than two images. Also, the display option is not restricted to a side-by-side view. Different display options are available and can be used to practice the current invention.

While the present invention is described above with respect to what is currently considered its preferred embodiments, it is to be understood that the invention is not limited to that described above. To the contrary, the invention is intended to cover various modifications and equivalent arrangements within the spirit and scope of the appended claims.

What is claimed is:

1. A method for comparing images on a computing system, comprising:
comparing a first image with a second image, wherein said first image and the second image having one or more image attributes to describe the first image and the second image; and the first image and the second image having one or more components, the components having one or more component attributes to describe the components; and the first image is compared to the second image by comparing components of the first image with components of the second image using a hierarchy of component attributes; and
creating a report based on the comparison of the components of the first image and the second image, the report providing a link associating the component attributes with the corresponding positions of components in the first image and the second image.

2. The method of claim 1, wherein comparing the first image to the second image further including:
identifying a list of component attributes to be used for comparison; and
creating a hierarchical list of component attributes to use for comparing components of images;

3. The method of claim 1, wherein the step of comparing a first image with a second image further comprising providing a first image and a second image with relevant components.

4. The method of claim 3, wherein the step of providing a first image and a second image further comprising:
receiving one or more image attributes of the images, the attributes defining the parameters for choosing one or more source for the first image and the second image and the associated components;
identifying one or more sources for providing a first image and a second image based on the image attributes, said first image and second image including corresponding components associated with it; and
identifying and extracting the first image and the second image with the associated components from the one or more sources for comparison based on the image attributes.

5. The method of claim 4, wherein the source includes any one or more from the group consisting of graphic images dynamically generated from a database, graphic images created by graphical illustrators maintained in a database, electronically scanned hand-drawn graphic images.

6. The method of claim 1, wherein image attributes provides distinctive description of the images and includes one or more of image identification, image name, image description, image identification, image revision description, and image revision date.

7. The method of claim 1, wherein component attributes provide distinctive description of the component and includes one or more of image identification, image name, component identification, component name, component type, component description, component configuration, component revision identification, component revision date and component revision description.

8. The method of claim 1, wherein comparing the first image to the second image further including:
identifying components in each image using the hierarchical list of component attributes;
verifying to ensure the identified components exist in both the images; and
building a list of matched components and unmatched components for each image based on verification.

9. The method of claim 1, wherein creating a report further comprising:
distinguishing the differences in the corresponding components of the first image and second image;
creating a report of distinguished differences of the corresponding components of the first image and the second image; and
providing a linked report linking the component attributes with the corresponding positions of unmatched components in the first image and the second image.

10. The method of claim 1, wherein the linked report linking component attributes with the corresponding positions of unmatched components is to enable a closer view of the distinguished differences in the relevant components.

11. A system for comparing images, comprising a processor for executing an analyzer module, wherein said analyzer module comprising:
a compare module for comparing a first image with a second image, wherein said first image and the second image having one or more image attributes to describe the first image and the second image; and the first image and the second image having one or more components, the components having one or more component attributes to describe the components; and the first image is compared to the second image by comparing components of the first image with components of the second image using a hierarchy of component attributes; and
a report module for creating a report based on the comparison of the components of the first image and the second image, the report providing a link associating the component attributes with the corresponding positions of components in the first image and the second image.

12. A system of claim 11, wherein the analyzer module further comprising a receive module for receiving a first image and a second image from one or more sources based on image attributes, the receive module further collaborating with the compare module by providing the images for comparison.

13. A system of claim 12, wherein receiving a first image and a second image further comprising:
receiving one or more image attributes to identify a first image and a second image from one or more sources;
identifying the first image and the second image from the one or more sources; and
extracting the first image and the second image for comparison from the identified sources.

14. A system of claim 12, further comprising an input device to receive one or more image attributes for a first image and a second image, said input device interfacing with the analyzer module executing on the processor.

15. A system of claim 11, wherein the analyzer module further comprising a list module, the list module collaborating with the compare module and report module, the list module generating a list of matched and unmatched components in the first image and the second image upon comparison of the respective image's component attributes.

16. A system of claim 11, further comprising a display device to display the report including the linked report and a report viewer to view the linked report.
